(19) United States
(12) Patent Application Publication
(10) Pub. No.: US 2012/0284654 A1
(43) Pub. Date: Nov. 8, 2012

(54) METHOD AND APPARATUS FOR RETURNING TO HOME SCREEN IN PORTABLE TERMINAL WITH MULTI-SOFTWARE PLATFORM

(75) Inventors: Ho-Bum KWON, Suwon-si (KR); Ju-Won AHN, Seoul (KR)

(73) Assignee: Samsung Electronics Co., Ltd., Suwon-si (KR)

(21) Appl. No.: 13/462,353

(22) Filed: May 2, 2012

(30) Foreign Application Priority Data
May 3, 2011 (KR) 10-2011-0041947

(51) Int. Cl. G06F 3/048

(52) U.S. Cl. 715/764

(57) ABSTRACT

A method and apparatus for returning to a home screen in a portable terminal with a multi-software platform configured to a sub software platform on a main software platform are provided. The method includes sensing a home button signal corresponding to input received through a user input unit, and returning, upon sensing the home button signal, a screen of the portable terminal to a home screen of the sub software platform when the sub software platform is being used and the home screen of the sub software platform is not being displayed at a time the input is received.

### PRIORITY

This application claims priority under 35 U.S.C. §119(a) to an application filed in the Korean Intellectual Property Office on May 3, 2011 and assigned Serial No. 10-2011-0041947, the entire content of which is incorporated herein by reference.

### BACKGROUND OF THE INVENTION

1. Field of the Invention

The present invention relates generally to a portable terminal with a multi-software platform, and in particular, to a method and apparatus for returning to a home screen of a main software platform or a sub software platform according to conditions, when a home button is selected while the sub software platform of an application program type is being executed on the main software platform.

2. Description of the Related Art

Along with the development of electronics and telecommunication industries, portable terminals such as mobile terminals (cellular phones), electronic notebooks, personal multifunctional terminals, etc., are becoming necessities in modern society. In particular, portable terminals have become important means for transmitting information.

As core functions and values of the mobile market are moving from voice communication services to data services that are based on various contents and applications, fierce competition has developed with respect to software platforms that provide various application services in mobile terminals like in desktop environments. Herein, software platforms refer to software packages that are mounted in terminals and may include operating systems, middleware, and basic applications, and these software packages provide various application services. Accordingly, as dependence of wireless Internet services and mobile apparatuses on applications and contents increases, competition for the leading position becomes fierce.

In light of this competition, terminals with multi-software platforms are increasingly mass-produced. Thus, a user may experience various platform environments supporting contents and application-based data service through a single terminal. One method for providing multi-software platforms is to execute a sub software platform of an application program type using virtualization on a main application platform. Generally, these software platforms provide a home screen. The home screen provides a user interface environment including icons corresponding to executable files of applications. When a certain application is executed, the home screen is changed into an operation screen. In order to return to the home screen, the application that is being executed may be closed or a home button may be selected. The home button outputs a signal to execute the operation for returning to the home screen. When the home button is selected, the application that is currently being executed may be forcibly closed, or may be kept operating in the background.

FIGS. 1A to 1D are diagrams illustrating a procedure of returning to a home screen in a touchscreen portable terminal with a typical multi-software platform. If the portable terminal is turned on, the portable terminal is booted with a main software platform, and displays a home screen 110 of the main software platform, such as shown in FIG. 1A. If an icon 112 for executing a sub software platform of an application program type is selected from the home screen 110 of the main software platform from the display shown in FIG. 1A, the sub software platform is executed to change the screen of the portable terminal from the home screen 110 of the main software platform to the home screen 120 of the sub software platform, such as shown in FIG. 1B. If a relevant icon 121 is selected from the home screen 120 of the sub software platform to execute an application from the display shown in FIG. 1B, the home screen 120 of the sub software platform is changed into an operation screen of the corresponding application, such as shown in FIG. 1C. A user may select a home button 10, such as shown in FIG. 1 C, in order to return to the home screen 120 of the sub software platform, but the screen returns to the home screen 110 of the main software platform, such as shown in FIG. 1D. Accordingly, if the 15 user desires to utilize the sub software platform again after selecting the home button, the user is inconvenienced by having to execute the sub software platform again.

### SUMMARY OF THE INVENTION

An aspect of the present invention is to address at least the above problems and/or disadvantages and to provide at least the advantages below. Accordingly, an aspect of the present invention is to provide a method and apparatus for a multi-platform in which a sub software platform of an application program type is executed on a main software platform, without limiting the usage of a home button for returning to a home screen to returning to the home screen of the main software platform.

Another aspect of the present invention is to provide a method and apparatus for returning to a home screen of a sub software platform instead of a home screen of a main software platform when a home button is selected while the sub software platform of an application program type is being executed on the main software platform and the home screen of the sub software platform is not being displayed.

According to an aspect of the present invention, a method for returning to a home screen in a portable terminal with a multi-software platform configured to execute a sub software platform on a main software platform is provided. The method includes sensing a home button signal corresponding to input received through a user input unit; and returning, upon sensing the home button signal, a screen of the portable terminal to a home screen of the sub software platform when the sub software platform is being used and the home screen of the sub software platform is not being displayed at a time the input is received.

According to another aspect of the present invention, an apparatus for returning to a home screen in a portable terminal with a multi-software platform capable of executing a sub software platform on a main software platform includes an input unit for receiving user input; an output unit for outputting images; a storage unit for storing data; and a control unit for returning a screen of the portable terminal to a home screen of the sub software platform when a home button signal corresponding to the user input is sensed while the sub software platform is being used and the home screen of the sub software platform is not being displayed at a time when the user input is received.

According to another aspect of the present invention, an electronic device is provided. The electronic device includes at least one processor; a memory; and at least one module stored in the memory and configured for execution by the at least one processor, the at least one module comprising at least one instruction, wherein the at least one instruction includes returning a screen of a portable terminal to a home screen of a sub software platform when the sub software platform is being used and the home screen of the sub software platform is not being displayed in response to a home button signal.

### BRIEF DESCRIPTION OF THE DRAWINGS

The above and other aspects, features and advantages of the present invention will become more apparent from the following detailed description when taken in conjunction with the accompanying drawings in which:

FIGS. 1A to 1D are diagrams illustrating a procedure of returning to a home screen in a touchscreen portable terminal with a typical multi-software platform;

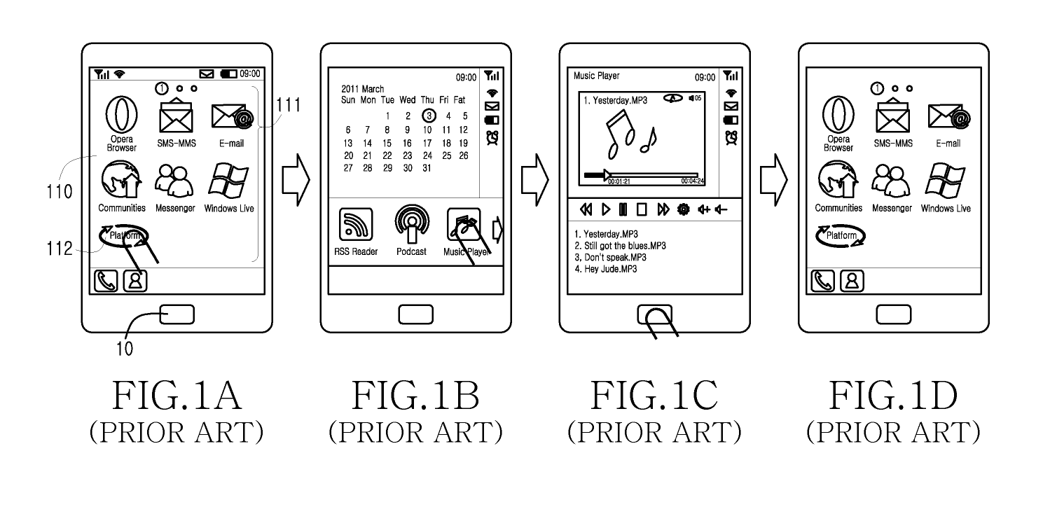

FIG. 2 is a block diagram illustrating a portable terminal according to an embodiment of the present invention;

FIGS. 3A to 3F are diagrams illustrating a procedure of returning to a home screen in a touchscreen portable terminal with a multi-software platform according to an embodiment of the present invention; and

FIG. 4 is a flowchart illustrating a procedure of returning to a home screen in a portable terminal with a multi-software platform according to an embodiment of the present invention.

### DETAILED DESCRIPTION OF EMBODIMENTS OF THE PRESENT INVENTION

Embodiments of the present invention are described herein below with reference to the accompanying drawings. In the following description, detailed descriptions of well-known functions or configurations may be omitted in order to avoid obscuring the subject matters of the present invention. Also, the terms used herein are defined according to the functions of the present invention. Thus, the terms may vary depending on users' or operators' intentions or practices. Therefore, the terms used herein must be understood based on the descriptions made herein.

Embodiments of the present invention may provide a method and apparatus for returning to a home screen of a sub software platform instead of a home screen of a main software platform when a home button is selected while the sub software platform of an application program type is being executed on the main software platform and the home screen of the sub software platform is not being displayed.

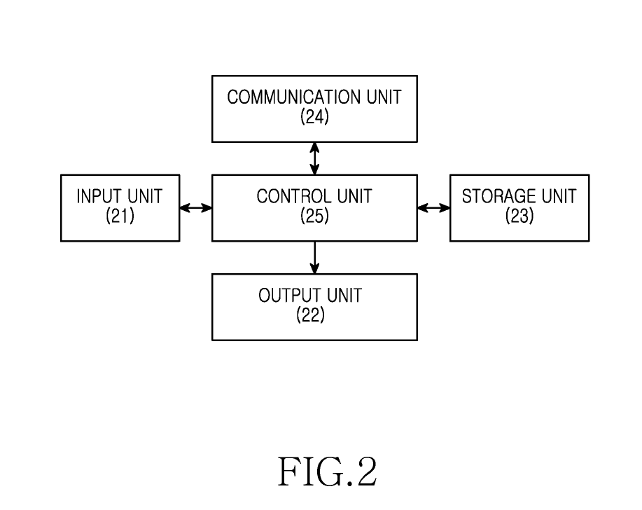

FIG. 2 is a block diagram illustrating a portable terminal according to an embodiment of the present invention.

Referring to FIG. 2, a portable terminal includes an input unit 21 for receiving user input, an output unit 22 for outputting voice or image, a storage unit 23 for storing data, a communication unit 24 for communication, and a control unit 25 for controlling overall operations of the portable terminal.

The input unit 21 outputs, to the control unit 25, an input signal corresponding to user input.

The output unit 22 receives and outputs voice or display data corresponding to the input signal according to the control of the control unit 25.

A touch sensitive display, also referred to as a touch screen herein, may be used as a display. Touch input may be performed via the touch sensitive display.

The storage unit 22 stores various data input and output when a certain program for controlling overall operations and control operations are performed. More specifically, the storage unit 22 stores information corresponding to a plurality of software platforms. When a switch signal (i.e., a signal for switching into other software platforms) is output from the input unit 21, the control unit 25 loads a corresponding software platform from the storage unit 22, and then drives the corresponding software platform. The method described hereunder according to embodiments of the present invention may be provided as at least one instruction in at least one software module stored in the storage unit. The software modules may be executed by the controller.

According to some embodiments of the present invention, a sub software platform of an application program type may be executed on a main software platform that has been booted. More specifically, if a home button signal is sensed while the sub software platform of the application program type is being executed on the main software platform, the control unit 25 controls returning to a home screen of the main software platform or a home screen of the sub software platform according to conditions.

A method of returning to a home screen in a portable terminal with a multi-software platform under a control of the control unit 25 is described as follows with reference to the accompanying drawings.

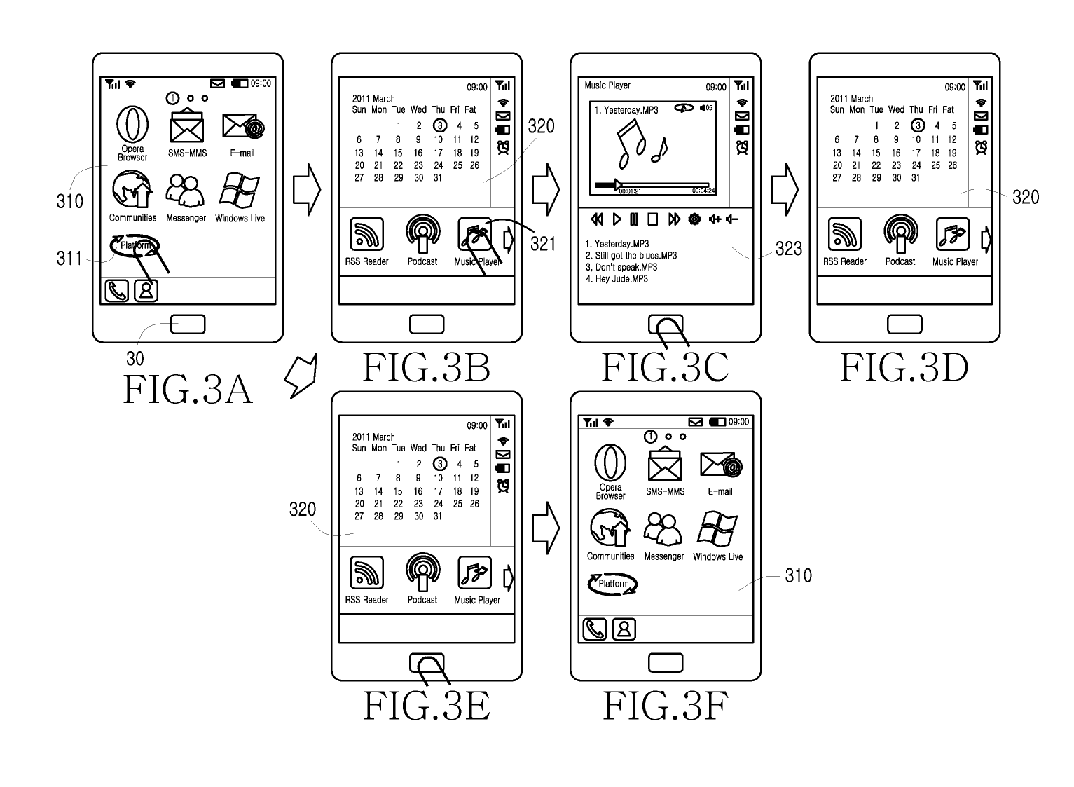

FIGS. 3A to 3F are diagrams illustrating a procedure of returning to a home screen in a touchscreen portable terminal with a multi-software platform according to an embodiment of the present invention.

Referring to FIG. 3A, when a portable terminal is turned on, the portable terminal is booted with a main software platform, and displays a home screen 310 of the main software platform. When an icon 311 for executing a sub software platform of an application program type is selected from the home screen 310 of the main software platform such as illustrated in FIG. 3A, the sub software platform is executed, and the home screen 310 of the main software platform is changed into a home screen 320 of the sub software platform, such as shown in FIG. 3B. When a corresponding icon 321 is selected from the home screen 320 of the sub software platform of the display of FIG. 3B, an application is executed, and the home screen 320 of the sub software platform is changed into an operation screen 323 of the corresponding application, such as illustrated in FIG. 3C. When a user selects a home button 30 during the operation of the corresponding application (e.g., music player) through the display of FIG. 3C, the operation of the application is stopped or is kept operating in the background, and then the screen of the portable terminal returns to the home screen 320 of the sub software platform, such as illustrated in FIG. 3D.

Additionally, when a user selects the home button 30 while the home screen 320 of the sub software platform is being displayed through the display of FIG. 3E, the screen is changed into the home screen 310 of the main software platform, such as illustrated in FIG. 3F. In this case, the sub software platform may be closed.

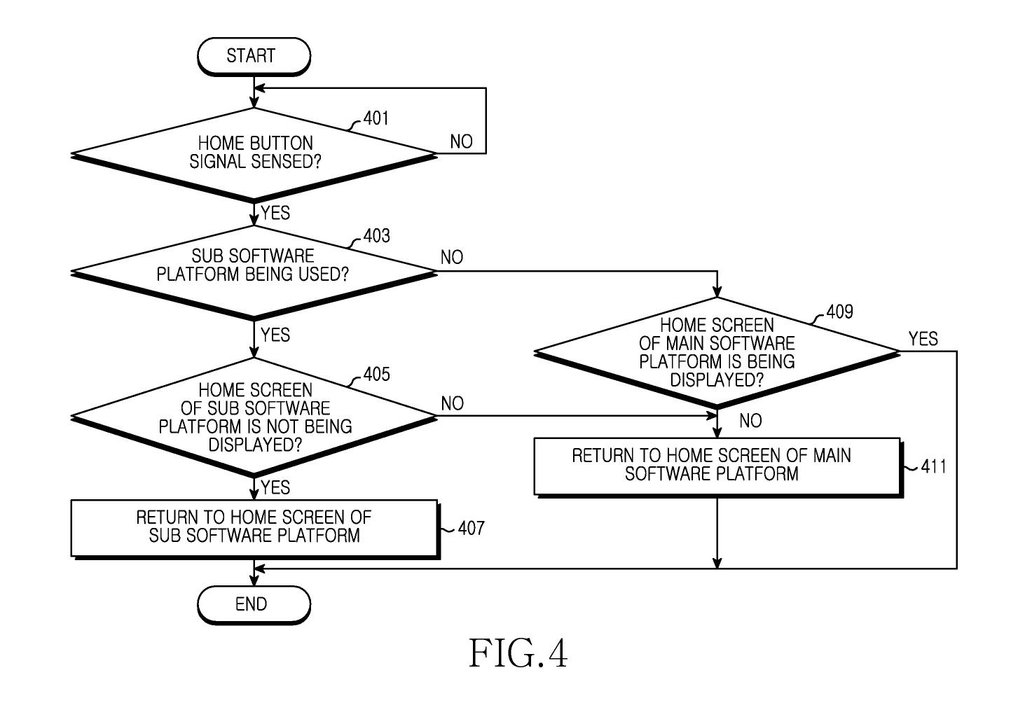

FIG. 4 is a flowchart illustrating a procedure of returning to a home screen in a portable terminal with a multi-software platform according to an embodiment of the present invention. As described above, a portable terminal with the multi-software platform according to an embodiment of the present invention may be booted with a main software platform. When a certain icon is selected from the home screen of the main software platform, the sub software platform of an application program type is executed. In this case, the screen is changed into the home screen of the sub software platform.

Referring to FIG. 4, the control unit 25 determines whether a home button signal is sensed, in step 401.

When the home button signal is sensed, the control unit 25 determines whether the sub software platform is being used, in step 403.

If the sub software platform is being used, the control unit 25 determines whether the home screen of the sub software platform is not being displayed in step 405. When the home screen of the sub software platform is not being displayed, for example, such as when an operation screen of an application executed with the sub software platform is currently being displayed, the control unit 25 processes the home button signal by returning to the home screen of the sub software platform, in step 407.

Although previous examples of the home button according to embodiments of the present invention refer a hardware button, the present invention is not limited thereto, and the home button may also be embodied as a software button, such as on a touchscreen, in accordance with embodiments of the present invention.

If the sub software platform is not being used (i.e., the main software platform is being used), the control unit 25 determines whether the home screen of the main software platform is being displayed in step 409. Upon a determination that the home screen of the main software platform is not being displayed, in step 409 (e.g., such as when an operation screen of an application executed with the main software platform is being displayed), the control unit 25 processes the home button signal to return to the home screen of the main software platform in step 411. Upon a determination that the home screen of the main software platform is being displayed in step 409, the control unit 25 ignores the home button signal and ends the procedure.

Embodiments of the present invention can be realized in the form of hardware, software or a combination thereof Any such software may be stored in the form of volatile or non-volatile storage such as, for example, a storage device like a Read Only Memory (ROM), such as erasable, rewritable, non-erasable, and non-rewritable ROMs, or in the form of memory such as, for example, Random Access Memory (RAM), memory chips, device or integrated circuits or on an optically or magnetically readable medium such as, for example, a CD, DVD, magnetic disk or magnetic tape, etc. Such storage devices and storage media are embodiments of machine-readable storage that are suitable for storing a program or programs comprising instructions that, when executed, implement embodiments of the present invention. Accordingly, embodiments of the present invention may provide a program including code for implementing an apparatus or a method according to embodiments of the present invention, such as claimed in any one of the claims of this specification and a machine-readable storage storing such a program. Still further, such programs according to embodiments of the present invention may be conveyed electronically via any medium such as a communication signal carried over a wired or wireless connection.

As described above, embodiments of the present invention can provide a multi-platform in which a sub software platform of an application program type is executed on a main software platform, and can also apply a home button for returning to a home screen to a sub software platform that is subordinate to the main software platform.

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A method for returning to a home screen in a portable terminal with a multi-software platform configured to execute a sub software platform on a main software platform, the method comprising:
sensing a home button signal corresponding to input received through a user input unit; and
returning, upon sensing the home button signal, a screen of the portable terminal to a home screen of the sub software platform when the sub software platform is being used and the home screen of the sub software platform is not being displayed at a time the input is received.

2. The method of claim 1, further comprising returning the screen of the portable terminal to the home screen of the main software platform when the sub software platform is being used and the home screen of the sub software platform is being displayed at the time the input is received.

3. The method of claim 1, further comprising returning the screen of the portable terminal to the home screen of the main software platform when the sub software platform is not being used and the home screen of the main software platform is not being displayed at the time the input is received.

4. The method of claim 1, further comprising ignoring the home button signal when the sub software platform is not being used and the home screen of the main software platform is being displayed at the time the input is received.

5. An apparatus for returning to a home screen in a portable terminal with a multi-software platform configured to execute a sub software platform on a main software platform, the apparatus comprising:
an input unit for receiving user input;
a storage unit for storing data; and
a control unit for returning a screen of the portable terminal to a home screen of the sub software platform when a home button signal corresponding to the user input is sensed while the sub software platform is being used and the home screen of the sub software platform is not being displayed at a time when the user input is received.

6. The apparatus of claim 5, wherein the control unit returns the screen of the portable terminal to the home screen of the main software platform when the home button signal is sensed while the sub software platform is being used and the home screen of the sub software platform is not being displayed at the time when the user input is received.

7. The apparatus of claim 5, wherein the control unit returns the screen of the portable terminal to the home screen of the main software platform when the home button signal is sensed while the sub software platform is not being used and the home screen of the main software platform is not being displayed at the time when the user input is received.

8. The apparatus of claim 5, wherein the control unit ignores the home button signal when the home button signal is sensed while the sub software platform is not being used and the home screen of the main software platform is being displayed at the time when the user input is received.

9. An electronic device, the device comprising:
at least one processor; and
a memory;
at least one module stored in the memory and configured for execution by the at least one processor, the at least one module comprising at least one instruction,
wherein the at least one instruction includes returning a screen of a portable terminal to a home screen of a sub software platform when the sub software platform is being used and the home screen of the sub software platform is not being displayed in response to a home button signal.

10. The method of claim 9, wherein the at least one instruction further includes returning the screen of the portable terminal to a home screen of a main software platform when the sub software platform is being used and the home screen of the sub software platform is being displayed at a time a predetermined input is received.

11. The method of claim 9, wherein the at least one instruction further includes returning the screen of the portable terminal to a home screen of a main software platform when the sub software platform is not being used and the home screen of the main software platform is not being displayed at the time a predetermined input is received.

12. The method of claim 9, wherein the at least one instruction further includes ignoring the home button signal when the sub software platform is not being used and a home screen of a main software platform is being displayed at a time a predetermined input is received.
